(19) United States
(12) Patent Application Publication
(10) Pub. No.: US 2014/0089441 A1
(43) Pub. Date: Mar. 27, 2014

(54) Method And System Of Transferring Electronic Messages Using An Instant Messaging Protocol

(71) Applicant: Szymon Lukaszyk, Katowice (PL)

(72) Inventor: Szymon Lukaszyk, Katowice (PL)

(21) Appl. No.: 14/115,969

(22) PCT Filed: May 21, 2012
(86) PCT No.: PCT/PL2012/000034

§ 371 Date: Nov. 6, 2013

(30) Foreign Application Priority Data
May 19, 2011 (PL) P 394944

(51) Int. Cl. H04L 12/58

(52) U.S. Cl. CPC H04L 51/04
USPC 709/206

(57) ABSTRACT

A method and system for transferring electronic messages (email), includes creating a primary email message by a sender using a sender email program and transmitting a P2P request message to a recipient mail. The request contains at least one P2P connection. A P2P connection is established between a sender local host (12b) and a recipient local host (11a, 13a) for receiving the primary email message by the recipient local host (11a, 13a). To facilitate this connection and advise the sender about recipient availability, so that the P2P session may start up as soon as it is initiated by the sender, the P2P connection parameters include an instant messaging protocol address of the sender and an instant messaging protocol establishes the P2P connection between the sender local computer system (12b) and the recipient local computer system. Preferably this Instant Messaging protocol is the Extensible Messaging and Presence Protocol (XMPP).

### CROSS REFERENCE TO RELATED APPLICATIONS

This application is a U.S. national stage of PCT International Patent Application no. PCT/PL2012/000034, filed 21 May 2012, which claims priority in Polish patent application no. P.394944, filed 19 May 2011, the entire contents of said applications being hereby incorporated herein by reference.

### TECHNICAL FIELD

The invention in general relates to a method and system for transferring electronic messages (emails), comprising the steps of creating a primary email message by a sender using a sender email program; transmitting a P2P request message to a recipient mail server, wherein said P2P request email message contains at least one P2P connection parameter; and establishing P2P connection between a sender local host and a recipient local host in order to receive said primary email message by the recipient local host.

### BACKGROUND OF THE INVENTION

A method and system of this kind has been disclosed in the international publication WO 2009/014464. Although in general it enables for delivering emails directly to a recipient via P2P channel, in some circumstances establishing such a P2P connection may be difficult.

Other solutions concerning optimizing an existing email transfer have been disclosed for example in applications US 2003/0236847 and WO 2006/123328.

Problems in establishing P2P connection between any two computers connected to the Internet arise mainly due to commonly used 32-bit Internet Protocol version 4 (IPv4), the allocated address pool of which has almost exhausted. On the other hand the 1 Pv6 protocol (2128 addresses). which would theoretically enable to assign a unique address to any device connected to the Internet is still not and may never be widely implemented. Computers (hosts) are therefore grouped in private networks, where they are identified by private addresses that may be freely duplicated in other private networks. Private networks are in turn connected to the Internet via routers to which a unique, public IP addresses are assigned. In order to allow a private network host located behind a router to connect with another host having a public IP address, mechanism known as Network Address Translation (NAT) is commonly used. However, setting-up a connection with a private network host from outside of the router is in general impossible unless some external public host is used.

Another problem in establishing P2P connection between any two hosts connected to the Internet, independent of private or public addressing thereof obviously arise if there are firewalls between them. In general firewalls are installed on routers (NAT/firewall) so that both the above problems in establishing P2P connection usually appear concurrently.

In order to alleviate these drawbacks and enable direct P2P communication between any two Internet hosts, at least one of which is behind a firewall, NAT or PAT (Port Address Translation), etc. various solutions have been proposed including communication protocols and servers, such as Simple Traversal of UDP through NATs (abbreviated STUN), Traversal Using Relay NAT (abbreviated TURN), Interactive Connectivity Establishment ICE (ICE) of various properties and development levels.

Recently Instant Messaging (IM) such as ICQ, Skype, Windows Live Messenger, Yahoo! Messenger, Facebook, Gadu-Gadu, etc. enabling for real-time transferring of text-based messages and information concerning current availability of registered users has gained popularity. Nonetheless, in comparison to email transmission based on well-grounded common standards (cf. e.g. RFC 1869 and RFC 1081), In instant messaging different, mainly incompatible technologies (transmission protocols, servers, client applications, etc.) are used and a unified common standard has neither been created nor accepted so far.

It has been an object of the present invention to provide a method and a system for transferring electronic messages (emails) via telecommunication network that would alleviate the aforementioned drawbacks in establishing direct P2P connection.

Another object of the present invention has been to provide a solution that would enable to inform a sender about current availability of a recipient and host or hosts the recipient uses at a given moment, in order to initiate transfer of an email message (data stream) to the selected recipient host as soon as it is possible.

### SUMMARY OF THE INVENTION

In order to accomplish the aforementioned and other objects, according to the present invention there is provided a method and system for transferring electronic messages (emails) via telecommunication network, as well as computer-readable storage medium containing executable instructions for such a system, that comprise technical features, in particular, there is described a method for transferring electronic messages (emails) via a telecommunication network comprising the steps of:

(a) creating a primary email message by a sender using a sender email program;

(b) transmitting a P2P request message to a recipient mail server, wherein said P2P request email message contains at least one P2P connection parameter;

(c) establishing a P2P connection between a sender local host and a recipient local host in order to receive said primary email message by the recipient local host, characterized in that, said P2P connection parameters Include an instant messaging protocol address of the sender.

It is advantageous to employ Extensible Messaging and Presence Protocol (XMPP) as the instant messaging protocol according to the invention.

XMPP enables for a real time transfer of messages and presence notification of users, each identified by a unique identifier known as Jabber ID or JID. The structure of JID is similar to an e-mail address (FQDA) with a username, @ symbol and a domain name (or IP address) of the server of user's account. Additionally, the same user may access the XMPP system simultaneously from a number of hosts using a “resource” i.e. a string that may be Included in the JID after a slash followed by the name of the resource (e.g. jan@jabber.org/mobile). Furthermore, compatibility of an e-mail address and JID used in XMPP protocol enables for using the same address to identify a user both during e-mail transmission and during XMPP transmission.

XMPP protocol is nowadays a highly standardized communication protocol (it is defined among others in RFC 3920, RFC 3921. RFC 3922, RFC 3923), and one of its values (similarly as in the case of present email transfer) is decentralization, i.e. lack of any central managing or registering server. Moreover, XMPP functionality is still under development while stable extensions are incorporated as new standards of XMPP and are published by XMPP Standards Foundation as XMPP Extension Protocols (abbreviated XEP).

Since basic data transmission according to XMPP uses open-ended XML streams, binary data must be first encoded to an appropriate transfer form (Base64, Quoted-Printable, etc.) before it can be transmitted in-band. Therefore large amount of binary data (e.g. large files) is best transmitted out-of-band, using in-band XML messages only to coordinate this out-of-band transmission. Such a solution has been proposed e.g. as Jingle XMPP Extension Protocol (XEP-0166) which is preferably employed to establish and maintain the P2P connection according to the present invention.

Terms computer system, computer, host, device connected to the Internet, etc., as used in this specification, denote all computer devices such as workstations, laptops, mobile devices, smartphones and other known to those skilled in the art.

Term Mail User Agent (MUA), as used in this specification, denotes any system capable to access user mailbox and preferably providing possibility to create and send email messages (e.g. MS Outlook, Mozilla Thunderbird) including browser based mail applications (webmail) such as mail.google.com, poczta.onet.pl, etc.

Term Integrated Mail User Agent (IMUA), as used in this specification, denotes Mall User Agent, in which at least a part of the present invention has been implemented. In particular IMUA may be provided with appropriate mechanisms of communication using SMTP, POP3, XMPP and other protocols. IMUA may have a form of an integrated application, that is an application featuring both functionality of a typical Mail User Agent as well as functionality of the present invention; may have a form of an extension (add-on, plug-in, etc.) integrated with a MUA, such as ThunderBridge extension for Mozilla Thunderbird (http://thunderbridge.eu). Such an extension may be executed along with the MUA or on request as a binary executable, dynamically linked library (DLL), script Interpreted by the MUA (e.g. java script) or combinations thereof. Furthermore IMUA may have a form of a kit comprising MUA and an external application that communicates with MUA for example by exchanging data streams transferred to and from an appropriate TCP socket of a localhost (such as ThunderBridge Daemon); may have a form of a packet analyzing application intercepting transmission of data between MUA and an external Mail Server; an applet controlled by internet browser (webmail IMUA) and various others that shall be apparent to those skilled in the art.

It is further assumed that IMUA user has an account on an instant messaging server, such as an XMPP server (JID account) that in this case may obviously be integrated (identical) with his or her email account (JID=FQDA), as in the Google Gmail system.

Moreover, although in the specification terms “user sends/receives”, “user host sends/receives”, etc. are widely used it shall be obvious to those skilled in the art that these sending and receiving sessions are controlled by commands that are sent and received by Integrated Mail User Agents defined above.

All RFC documents (IETF publications) and XEPs quoted in this specification are incorporated in this specification by reference.

### BRIEF DESCRIPTION OF DRAWINGS

The invention has been illustrated below in exemplary embodiments and with reference to the figures of the drawing, on which:

FIG. 1 schematically illustrates a communication network along with a typical components that may be used to implement the present invention;

FIG. 2 schematically illustrates an exemplary transmission of an email message, according to the invention, along with employed hosts and different transmission protocols;

FIG. 3 schematically illustrates an exemplary transmission of an email message, according to the invention. where a recipient mail server is integrated with the recipient XMPP server;

FIG. 4 Illustrates a simplified message sequence chart of an exemplary transmission of an email message, according to the invention, to a “new” recipient; and

FIG. 5 illustrates a simplified message sequence chart of an exemplary transmission of an email message, according to the invention, to an “existing” recipient.

### DETAILED DESCRIPTION OF PREFERRED EMBODIMENTS

FIG. 1 schematically illustrates Internet 1 and some of devices or hosts connected to it, such as workstations 11, laptops 12, mobile devices 13, servers 21-24 and routers 25.

In general hosts connected to the Internet can be classified in two groups: the first group of hosts (21-25, 11b) having public IP addresses, unique within the entire Internet. and the second group of hosts (11a, 12, 13) having private (non-unique) IP addresses and connected the Internet through routers 25 having unique public IP addresses.

Hosts of the first group are in general accessible for connections initiated by hosts of the first and the second group so that they usually perform functions of servers providing specific services for the other hosts, such as ftp servers, http servers. database servers, mail servers commonly referred to as Mail Transfer Agent (MTA), etc. FIG. 1 illustrates only a few servers that may be employed to perform a transmission method according to the invention. These are MTA servers 22 using for example Sendmail. Postfix or MS® Exchange Server software, XMPP servers 23 using for example Citidel, Openfire or Prosody software, STUN servers 21 offering functionality defined in RFC3489 (for example Vovida) and relay servers 24 relaying network traffic between hosts they are connected to.

Hosts of the second group are usually grouped into local networks 3a, 3b (housing estate, office, corporation, etc.) and have private IP addresses unique within a given local network (such as 192.168.0.1). They are in general inaccessible for external connections but may initiate connections with hosts of the first group by means of Internet routers of that private network.

The invention shall now be described in exemplary embodiments and compared with a presently used method of transferring emails. For simplicity and to increase clarity of further explanations it is assumed that user or host A (further Alice) sends an email to user or host B (further Bruno), wherein Alice has an e-mail account (FQDA) alice@foo.org at the Mail Server 22a and may connect to the Internet 1 by a laptop 12b or a workstation 11b and Bruno has an e-mail account (FQDA) bruno@bar.com at the Mail Server 22b and may connect to the Internet 1 by a workstation 11a or a mobile phone 13a.

### Example A (Comparative)

Present Email Transfer

Presently used email message transmission, e.g. between hosts 12b and 11a, usually takes place as illustrated in FIG. 1:
1) Alice MUA initiates connection (31a) through a router 25b between Alice laptop 12b and Alice MTA 22a (as defined in her email account settings) and delivers the message to server 22a according to SMTP (sometimes an additional in-between mail submission agent (MSA) is used in transmission 31a);
2) Server 22a initiates a connection (31b) with Bruno MTA 22b (which it finds querying DNS system for MX record for domain bar.com of the Bruno FQDA bruno@bar.com) and delivers the message to the server 22b according to SMTP (sometimes an additional in between mail delivery agent (MDA) is also used in transmission 31b);
3) The message may be downloaded from the server 22b according to POP3 or IMAP protocols right after Bruno MUA initiates a connection with Bruno MTA 22b. Depending on which host Bruno uses, this connection may be established by Bruno workstation 11a through router 25c (connection 31c) or by Bruno mobile device 13a through router 25a (connection 31d). After the message is downloaded it may be deleted or left on the server 22b. In the latter case, it may be downloaded again by another authorized Bruno Mall User Agent. Usually mobile devices are configured with an option “leave copies of the messages at the server”.

On FIG. 1 direction of Initiating connections is illustrated by arrows, wherein solid line arrows denote direction of data transfer matching direction of initiating connection (initiator sends or uploads data) and dashed line arrows denote direction of data transfer opposite to direction of initiating connection (initiator receives or downloads data).

Certain disadvantages of the above described present email transfer system are apparently visible, to name but the few:
1. at least three independent connections 31a, 31b and 31c or 31d are required which greatly reduces network bandwidth and network performance. in particular when physical locations of particular hosts are absolutely arbitrary;
2. the message is saved prior further delivery on each of the MTA servers 22a, 22b, 22c so that It may be illegitimately intercepted and copied. It is also possible to copy selectively only the messages coming from a sender and/or going to a recipient having specific email addresses since these fields are usually not encrypted if an email encryption is used. Even if an encryption, like STARTTLS, takes place between individual SMTP relays, it may not prove satisfactory since as soon as a message is copied it may be decrypted e.g. using a brute force algorithm and accepting the time that this process may take;
3. the message does not reach the recipient at once but only when s/he initiates connection 31c, 31d with the MTA server 22b;
4. most MTAs are configured with volume quotas on transferred and stored messages, which makes It impossible to transfer messages with large attachment(s);
5. MTAs accept any message coming from another MTA server which facilitates spread of unsolicited messages (SPAM). Verification of the credibility of the sending MTA by checking if its address exists on the public lists of SPAM spreading servers is only a partial solution since even the short period between booting up a brand new spam server and placing its address at such a SPAM-servers list is quite sufficient for a spammer to deliver bulk of unsolicited messages to millions of email users.

The most convenient way of email transmission would certainly be direct transmission between Alice host 12b and Bruno host 11a or 13a. Such a transmission would lack disadvantages 1-4 above. Unfortunately it is impossible to simply establish such a P2P email transmission, inter alia, due to the following reasons:
a) Bruno may not be connected to the network at this moment. Assuming however that he is connected, then:
b) Alice may not know which host Bruno uses at this moment (workstation 11a, mobile device 13a or another device he may be logged in) and she may not determine where she should send her message. Assuming however that she knows the correct host, then:
c) Alice may not know the IP address of the Bruno host. Assuming however that she knows this IP address, then:
d) Most likely Bruno host is hidden behind the firewall (25a, 25c) and is not publicly addressed (i.e. it belongs to the second group of hosts).

In the most general case the sole information about Bruno that Alice knows and may use to transfer her email message to Bruno is his email address (bruno@bar.com).

### Example B

Email Transfer According to the Present Invention

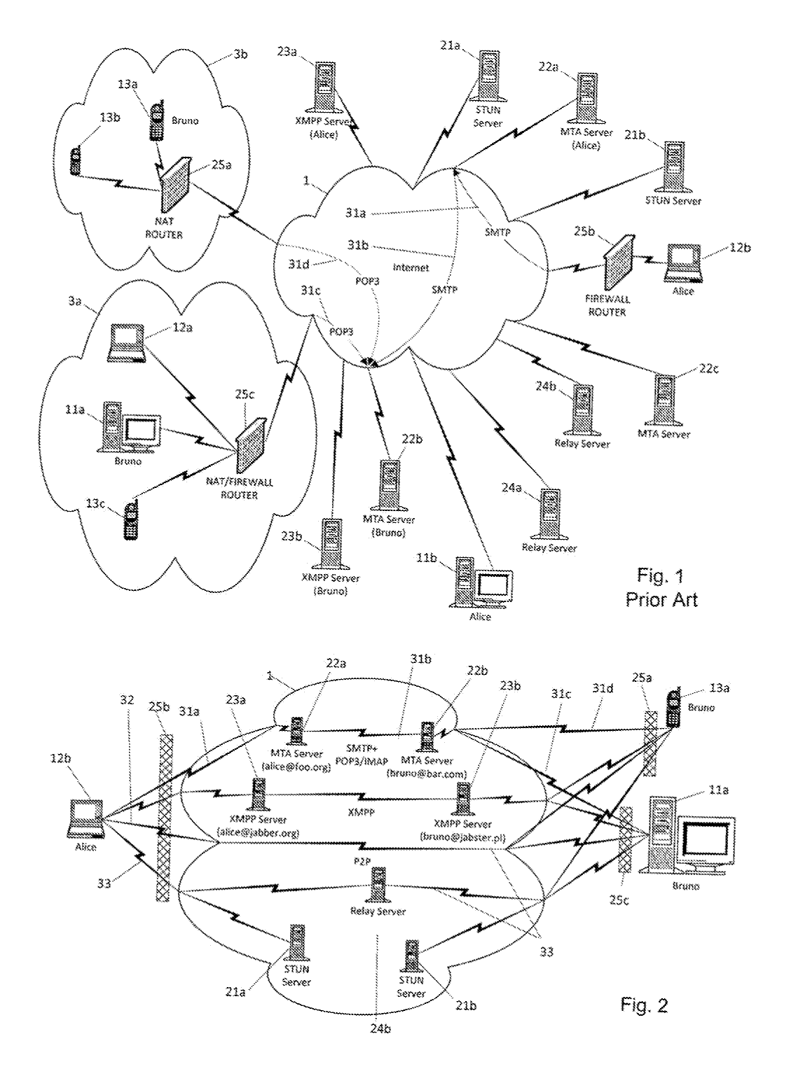

FIG. 2 illustrates an exemplary P2P email transmission according to the invention. XMPP protocol is used here as an instant messaging protocol, although other instant messaging protocols are equally possible. It is assumed that Alice has her XMPP account (JID) alice@jabber.org at the XMP P server 23a, while Bruno has his JID bruno@jabster.pl at the XMPP server 23b. FIG. 2 also shows transmission layers (protocols): SMTP+POP3/IMAP transmission 31 (the only email transmission protocol used so far), XMPP transmission 32 and direct P2P (including relayed) transmissions 33. Alice and Bruno may use local IMUAs or IMUAs controlled by Web browsers (Webmail IMUA). As shall be explained below these assumptions are irrelevant to the practical Implementation of the invention and each user (sender and recipient) may use any form of IMUA on any host connected to the Internet.

Exemplary email transmission according to the present invention depicted on FIG. 2 may include the following steps:
1. Alice IMUA after start-up logs on Alice XMPP server 23a with Alice JID (alice@jabber.org) and password. After logging, Alice XMPP server 23a broadcasts to all XMPP users, that subscribed to Alice presence (presence subscription state “From” or “Both”) an information about her availability. Alice may obviously change this availability to “away”, “Do Not Disturb”, etc. On the other hand Alice IMUA receives information about current availability of users (and their hosts), that she subscribed to (presence subscription state “To” or “Both”, cf. RFC 6121).
2. Alice creates in her IMUA a message to Bruno (the primary message) and initiates its sending to his email account bruno@bar.com.
3. If Alice does not know Bruno JID (a “new” recipient) the following step 4 and subsequent steps are performed, otherwise (an “existing” recipient) step 9 is performed.
4. Alice IMUA withholds sending the message created in step 2 for a predetermined period T1, for example for 2 minutes. Instead of sending the primary message in its original form, Alice IMUA prepares a P2P request message that contains P2P connection parameters such as Alice JID, unique identifier, list of attachments (file type, file size), subject, body and other parameters of the primary message, IP address of Alice host 12b, IP address of Alice router 25b, etc. These data may be provided in textual or binary form in the body or as attachment(s) of the P2P request message and also may be encrypted.

Obviously the P2P request may be a new automated email message or may simply be created by modification of the primary message for example by striping it off attachments and supplementing it with the required P2P connection parameters above.

Furthermore Alice IMUA may send to Alice XMPP server 23a a clearance message In which she informs about her intention to send her primary message to bruno@bar.com email account, for example providing within this clearance message the unique Identifier of the P2P request message (at this point Alice does not know Bruno JID).

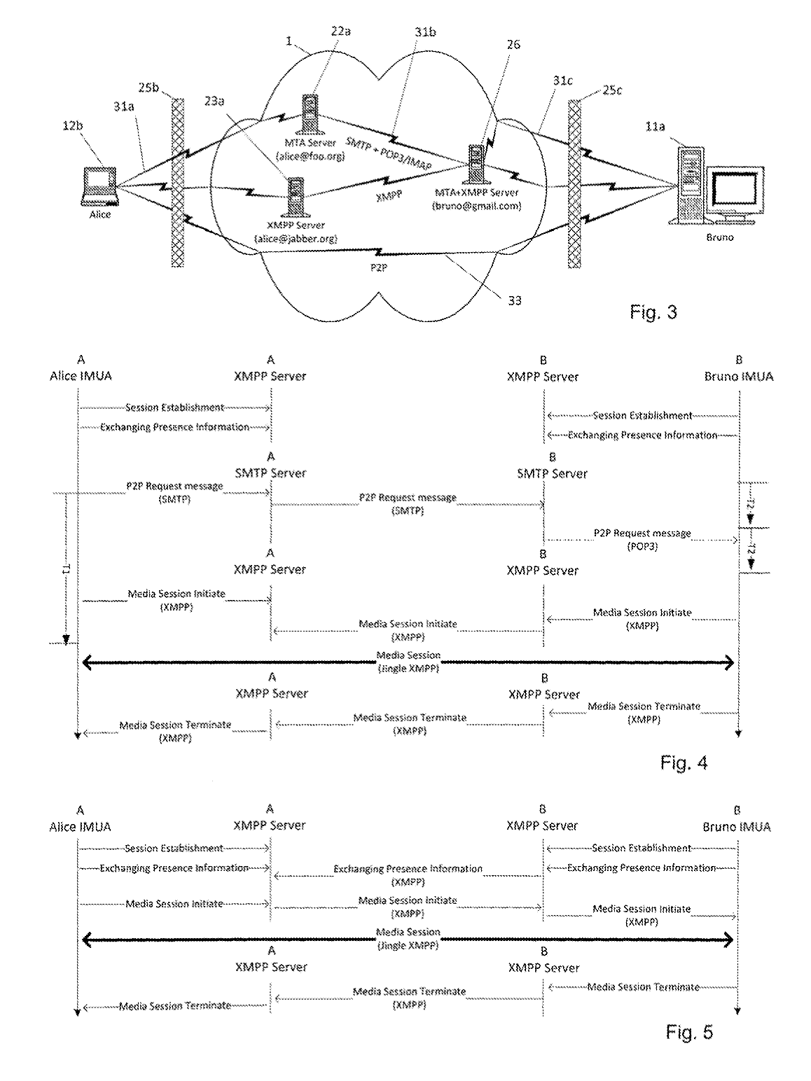

Yet furthermore Alice IMUA may attempt to send through her XMPP server 23a a direct subscription request to Bruno email account bruno@bar.com since this account may happen to be an integrated email and XMPP account of Bruno. If this would be the case, i.e. if the subscription request would reach Bruno XMPP server, no P2P request message may be required and parties may negotiate P2P connection parameters directly via XMPP (cf. FIG. 3 for XMPP servers 23a and integrated MTA+XMPP server 26) so that step 8 would be performed.
5. The P2P request message is delivered in a typical manner to Bruno email account (bruno@bar.com) via SMTP+POP3/IMAP from Alice host 21b to Alice MTA outgoing mail server 22a (connection 31a, SMTP) and then from Alice MTA server 22a to Bruno MTA Incoming mail server 22b (connection 31b, SMTP).
6. Bruno IMUA after start-up logs on Bruno XMPP server 23b with Bruno JID (bruno@jabster.pl/worksation and/or bruno@jabster.Ql/mobile in dependence of the host Bruno uses at the moment) and password. Similarly to step 1 above, Bruno XMPP server 23b broadcasts to all XMPP users that subscribed to Bruno presence information about his availability.
7. Bruno IMUA periodically checks if any new messages are present at Bruno incoming mail server 22b, wherein period between checks (T2) may be shorter than period T1 predetermined for sending (cf. step 4 above). T2 may be set for example to 1 minute. If any new message is detected or downloaded from MTA server 22b Bruno IMUA may determine if this is a P2P request message. Such determination may for example involve comparing a message header, body or a message attachment with a predefined P2P request message template. This determination may also involve decrypting data contained in a P2P request message.
8. After a P2P request is received, Bruno IMUA knowing Alice P2P connection parameters such as Alice FQDA and JID, IP address of the Alice host 12b, IP address of a router 25b, through which Alice connects with the Internet, unique identifier of the P2P request message, etc. may connect with the Alice IMUA. For example Bruno IMUA may:
a) knowing IP of the Alice host 12b, check if this is a public IP address and if so—attempt to establish direct P2P connection with Alice host. If—as in the case illustrated in the drawing—it is not a public address, then:
b) knowing IP address of Alice router 25b, check if this is the IP address of Bruno router (25a or 25c) and if so (both Bruno and Alice operate within the same LAN)—attempt to establish direct P2P connection with Alice host at her private IP address. If—as in the case illustrated in the drawing—it is not the same network, then:
c) knowing Alice JID, display a message asking if Bruno wants to add Alice (JID) to his contact list (roster), wherein negative response may disallow Alice to send her primary message, as well other messages to Bruno via P2P in the future:
d) knowing Alice JID, send via Bruno XMPP server 23b to Alice XMPP server 23a an Outbound Subscription Request (as defined in RFC 6121) providing unique P2P request message ID to identify such a request:
e) knowing Alice JID, send via Bruno XMPP server 23b to Alice XMPP server 23a a clearance message in which he informs about his willingness to receive Alice primary message, for example providing within this clearance message the unique identifier of the received P2P request message (cf. step 4 above);
f) knowing Alice FQDA, send to Alice IMUA via SMTP+POP3/IMAP protocols (31c or 31d, 31b and 31a) P2P confirmation message containing Bruno JID.
9. P2P transmission begins as soon as the parties exchanged parameters necessary for a P2P connection and Jingle protocol defined in XEP-0166 (incorporated herein to the content of the present application by reference) may be used to transfer Alice primary message to Bruno. In general Jingle contains three parts of various specifications: core session management, transmitted application (data) format (e.g., voice chat, video chat, file transfer) and transport methods (e.g., TCP, UDP, ICE, application-specific transports). Initiation of a data stream in a Jingle session may include the following steps (in case of Alice and Bruno):
a1) Alice (Initiator, message sender) sends to Bruno (roster member, target, message recipient) a connection XMPP stanza; if Bruno accepts the connection in reply it sends to Alice an acceptance stanza. or
a2) Bruno (initiator, message recipient) sends to Allee (roster member, target message sender) a connection XMPP stanza; if Alice accepts the connection it sends to Bruno an acceptance stanza,
b) Both parties negotiate the data connection details over XMPP exchanging XMPP stanzas concerning possible connection pathways (transport candidates), security levels, acceptable data formats, etc.
c) The Peer to Peer media session begins between Alice and Bruno and continues until a redirect or terminate request, or until the data channel is broken.

It is an advantage of a Jingle XMPP protocol that it implements mechanisms enabling for direct communication between hosts located behind firewalls, NAT, PAT, etc., as defined In XEP-0176 (Jingle ICE Transport), XEP-0177 (Jingle Raw UDP Transport), XEP-0179 (Jingle IAX Transport), XEP-0234 (Jingle File Transfer), XEP-0251 (Jingle Session Transfer), XEP-0278 (Jingle Relay Nodes Jingle Nodes Project) and many others. According to Jingle protocol signaling XMPP channel is separated from data transmission channel; application format is separated from data transmission channel; application format is separated from transport method, and furthermore deleting, modifying and adding new application formats and transport methods is possible even during the progress of a connection. STUN servers 21a (Alice) and 21b (Bruno), as well as relay server 4b may obviously be employed in the P2P transmission. Open source library “libjingle” (https://developers.google.com/talk/libjingle) by Google Inc. is one of Jingle implementations that may be employed for P2P transmission according to the present invention.

Obviously if Alice IMUA knows Bruno JID and has an information about his present availability at a given host (11a or 13a), that he uses at the moment, only step 9 above shall be realized.

If the P2P request message, already received by Bruno (step. 8 above) is a modified version of Alice primary email message (e.g. a primary message without attachments) after successful P2P delivery of the missing parts of the primary message, it may be restored again to its original form by Bruno IMUA.

An exemplary email transmission of the present invention shown in FIG. 2 fails, in particular, if during period T1 Alice IMUA has not registered any reaction in response to dispatched P2P request message. It may happen In particular if:
a) the P2P request message has not been received from server 22b (transmission 31c or 31d) by any of Bruno mail programs, for example because Bruno has been offline; or
b) Bruno MUA is unable to properly interpret the P2P request message as an invitation to establish P2P connection, since it does not implement the functionality of the present invention, i.e. the IMUA used by Alice. In this case however information about the advantages of the system of the present invention and opportunities (e.g. a hyperlink) for its installation may be provided to Bruno in a body of the P2P request message (it is a normal email message anyway);
c) Bruno IMUA recognized the P2P request message but parameters thereof do not correspond to those accepted by Bruno. For example Bruno my block reception of particular attachment types, attachments exceeding predefined threshold (e.g. larger than 100 MB), etc. Bruno might have also blocked Alice indicating her FQDA, JID or Internet domain at his black Ilst of contacts to be rejected.

In a case of a failed transmission, for example:
a) Alice may be informed e.g. with a message box that transmission has failed,
b) Alice IMUA may automatically attempt to send message in a common way as discussed above with reference to FIG. 1 and/or
c) Alice IMUA may attempt to deliver message according to the method of the present invention after a certain period of time.

It is known to integrate MTA server an XMPP server. System of this kind has been depicted on FIG. 3 where Bruno uses such an integrated MTA+XMPP server 26 and his FQDA bruno@gmall.com is the same as his JID.

FIG. 4 and FIG. 5 depict simplified sequence diagrams of commands for exemplary email transmissions of the present Invention. Diagram of FIG. 4 illustrates an example of sending a message to a “new” recipient, i.e. user with whom a sender has not corresponded before, that comprises steps 1 to 7, 8(e) and 9 as described above. Diagram of FIG. 5 illustrates an example of sending a message to an “existing” recipient, i.e. user to whom a sender has successfully delivered a message sometimes before and now has a subscription of a presence of that user, which comprises steps 1, 2, 6 and 9 described above. Direct data transfer depicted on the drawing as a “Media Session” may obviously involve not only a transfer of files but also a bidirectional transfer of voice, video and other application formats between users A and B.

The above exemplary embodiments of the invention describe a transmission between one sender and one recipient. It is obvious however that analogous transmission may take place from one sender to many recipients. Furthermore, individual steps (stages) have been described in a specified sequence. It is obvious however that in alternative embodiments of the invention they may be executed in a different order and that some of them may be omitted. Although the present description indicates some exemplary implementations of the invention, those skilled in the art shall easily notice that it is possible to develop various modifications and variants of the presented embodiments, which also be based on the idea of transmission of a P2P request, and in particular typical transmission of a P2P request email message, in order to establish direct P2P connection between IMUAs of a sender and a recipient. Therefore these modifications and variants should also be considered as covered by the scope of the invention and only the content of the patent claims should be regarded as a proper definition of the invention.

1. A method for transferring electronic messages (emails) via telecommunication network comprising the steps of:
(a) creating a primary email message by a sender using a sender email program;
(b) transmitting a P2P request message to a recipient mail server, wherein said P2P request email message contains at least one P2P connection parameter;
(c) establishing a P2P connection between a sender local host and a recipient local host in order to receive said primary email message by the recipient local host, wherein said P2P connection parameters include an instant messaging protocol address of the sender.

2. The method according to claim 1, further comprising employing an instant messaging protocol to establish said P2P connection between the sender local computer system and the recipient local computer system.

3. The method according to claim 1, further comprising transferring at least part of said primary email message through a data transmission channel which is distinct from different to an instant messaging transmission channel.

4. The method according to claim 1, characterized in that, said instant messaging protocol is an Extensible Messaging and Presence Protocol (XMPP).

5. The method according to claim 4, wherein a Jingle XMPP Extension Protocol (XEP-0166) is employed to establish and maintain said P2P connection.

6. The method according to claim 1, characterized in that said P2P request is an email message and is transmitted using a known method of transferring emails.

7. The method according to claim 6, characterized in that, said P2P request email message is created by a modification of said primary message.

8. The method according to claim 1, characterized in that, said P2P request is an instant messaging protocol message.

9. A system of transferring electronic messages (emails) via telecommunication network comprising a sender local host, a recipient local host and at least one recipient mail server connected with each other via a telecommunication network characterized in that, the sender local host and the recipient local host are configured to execute all the steps of the method defined in claim 1.

10. A computer-readable storage medium containing executable Instructions for a system of transferring electronic messages via telecommunication network, characterized in that, said executable instructions comprise an execution of all the steps of the method defined in claim 1.

11. The method according to claim 7 wherein said modification comprises striping it off attachments and supplementing the primary message with said at least one P2P connection parameter.

12. The method according to claim 8, wherein the instant messaging protocol message is an XMPP stanza.
